(19) United States
(12) Patent Application Publication
(10) Pub. No.: US 2005/0147641 A1
(43) Pub. Date: Jul. 7, 2005

(54) Plastic water and beverage bottle and manufacturing process thereof

(76) Inventor: Qi Yu, City of Industry, CA (US)

Correspondence Address: DAVID AND RAYMOND PATENT GROUP, 1050 OAKDALE LANE, ARCADIA, CA, 91006, US

(21) Appl. No.: 10/749,967

(22) Filed: Jan. 2, 2004

(51) Int. Cl. C08K 3/00

(52) U.S. Cl. 424/412; 523/122

(57) ABSTRACT

A water and beverage container includes a plastic made container body, a plastic made container cap sealingly covering the opening of the container body, a protective arrangement on the liquid container, wherein the protective arrangement comprises a nano titanium oxide and a far infrared ray emitter respectively for providing anti-germ, water softening and ultra-violet resistant functions, so as to preserve the quality of water or beverage contained inside the bottle.

### BACKGROUND OF THE PRESENT INVENTION

1. Field of Invention

The present invention relates to a water and beverage bottle with a protective arrangement, and more particularly to a plastic water and beverage bottle which comprises a protective arrangement comprising a nano titanium oxide and a far infrared ray emitter provided on the plastic bottle for providing anti-germ, water softening and ultra-violet resistant functions, so as to preserve the quality of water or beverage contained inside the plastic bottle.

2. Description of Related Arts

Bottled water and beverages are inexpensive, convenient and easy to store, as a result, they are very common in our everyday life. Almost everyone would come across this sort of beverages everyday, whether the beverages are in form of bottled water for water dispensers served in offices or homes, or handy bottled beverages available in corner stores.

Bottled water and beverages are very popular also due to the fact that people prefer them to water straight from the tap. The reason is that sources of water available straight from the tap are very often not reliable due to pollution of the sources, contamination of the taps and water hardness. And although water hardness is not known to causes health risks, it does affect the taste of the water and the drink made by from it.

However, the quality of the contents inside a plastic bottle can easily be altered or contaminated, especially for small bottled beverages, through manual handling of the plastic bottles, contents being drunk directly out of the container, transportation, sunlight and incorrect storage conditions. Also, despite however sterilized the drink is, there is still a minute amount of germs present in the drink.

Many people also have the habit of reusing the plastic bottle after finishing the content. They thought that that is an environmental friendly act, however, they do not realize that they are creating health problems for themselves. Recent research has proven that plastic bottles of beverages available in supermarkets are not suitable for refilling and should be disposed of once the contents are consumed. The reason is that germs, accumulated on the bottle collected from the atmosphere, manual handling and contents being drunk directly from the containers, multiply rapidly under the perfect conditions: moist, warmth and dark.

As a result, despite the fact that bottled beverages is convenient, it posts health hazard if the user reuses the plastic bottle, or creates a lot of pollution if it is disposed of after one single use. Thus, the plastic bottles require improving to minimize health hazard and pollution problem.

### SUMMARY OF THE PRESENT INVENTION

A main object of the present invention is to provide a plastic water and beverage bottle which comprises a protective arrangement provided on an exterior surface of any conventional plastic water and beverage container, for providing a user with contamination free and healthy beverage.

Another object of the present invention is to provide a plastic water and beverage bottle, wherein the protective arrangement comprises a far infrared ray emitter emits anions and far infrared rays, such that the far infrared rays act as a carrier carrying the anions to neutralize the negative environment that favors bacterial growth, thereby inhibiting bacterial growth.

Another object of the present invention is to provide a plastic water and beverage bottle, wherein the far infrared ray emitter of the coating allows the container to remain germs free, providing a container that is reusable, so as to minimize environmental pollution due to the necessity of disposing of the containers after a single use.

Another object of the present invention is to provide a plastic water and beverage bottle, wherein the far infrared ray emitter also softens hard water, so as to eliminate the strange taste in water due to water hardness.

Another object of the present invention is to provide a plastic water and beverage bottle, wherein the protective arrangement further comprises nano titanium oxide, to screen the water or beverage inside the plastic bottle from ultra-violet light, preventing the quality of water or beverage from being altered by ultra-violet light.

Another object of the present invention is to provide a process of manufacturing a plastic water and beverage bottle, wherein the process comprises a step of coating a plastic bottle with a layer of chemical, so as to provide the plastic bottle with a layer of nano titanium and far infrared ray emitter.

Another object of the present invention is to provide a process of manufacturing a plastic water and beverage bottle that is capable of allowing manufacturers of drinks and beverages to benefit from the coating, without the need of altering their design of plastic bottles.

Another object of the present invention is to provide a process of manufacturing a plastic water and beverage bottle, wherein the process comprises a step of forming a compound material by mixing together a plastic, a predetermined amount of nano titanium and a predetermined amount of far infrared ray emitter, a step of forming a plastic bottle using the compound material, so as to provide the plastic bottle with a layer of nano titanium and far infrared ray emitter.

Another object of the present invention is to provide a process for manufacturing the plastic water and beverage bottle, wherein the manufacturing method does not require expensive machines nor involve complicated structure so as to minimize the manufacturing cost of the plastic bottle. Therefore, the present invention successfully provides an economic and efficient solution for providing a plastic bottle that is anti-germ, capable of softening hardness of water and resisting ultra-violet light, so as to preserve the quality of water or beverage contained inside the plastic bottle.

Accordingly, in order to accomplish the above objects, the present invention provides a plastic water and beverage bottle for preserving a liquid, comprising:
a liquid container comprising a plastic made container body having a liquid chamber for storing the liquid therein and an opening communicating with the liquid chamber, and a plastic made container cap detachably sealing at the opening of the container body to enclose the liquid chamber; and
a protective arrangement provided on the liquid container, comprising:
a nano titanium oxide for blocking ultra-violet light entering into the liquid chamber of the liquid container; and
a far infrared ray emitter mixed with the nano titanium oxide, wherein the far infrared ray emitter is adapted for emitting far infrared rays penetrating into the liquid chamber to depolarize negative ions of the liquid, in such a manner that the protective arrangement forms as a germ barrier for keeping the liquid in the liquid container in a germ-free manner.

The present invention has an alternative embodiment, wherein the present invention provides a process of manufacturing a plastic water and beverage bottle which comprises the steps of:
(a) providing a liquid container comprising a plastic made container body having a liquid chamber for storing the liquid therein and an opening communicating with the liquid chamber, and a plastic made container cap detachably sealing at the opening of the container body to enclose the liquid chamber;
(b) mixing a predetermined amount of far infrared ray emitter with a nano titanium oxide to form an anti-germ solution, wherein the nano titanium oxide is for blocking ultra-violet light entering into the liquid chamber of the liquid container, and the infrared ray emitter is adapted for emitting far infrared rays penetrating into the liquid chamber to depolarize negative ions of the liquid; and
(c) applying the anti-germ solution on the liquid container, wherein the anti-germ solution forms as a germ barrier for keeping the liquid in the liquid container in a germ-free manner.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a plastic water and beverage bottle according to a preferred embodiment of the present invention.

FIG. 2 is a flow chart illustrating the manufacturing process of the plastic water and beverage bottle according to the above preferred embodiment of the present invention

FIG. 3 is a perspective view of a plastic water and beverage bottle according to an alternative embodiment of the present invention.

FIG. 4 is a flow chart illustrating the manufacturing process of the plastic water and beverage bottle according to the above alternative embodiment of the present invention.

### DETAILED DESCRIPTION OF THE PREFERRED EMBODIMENT

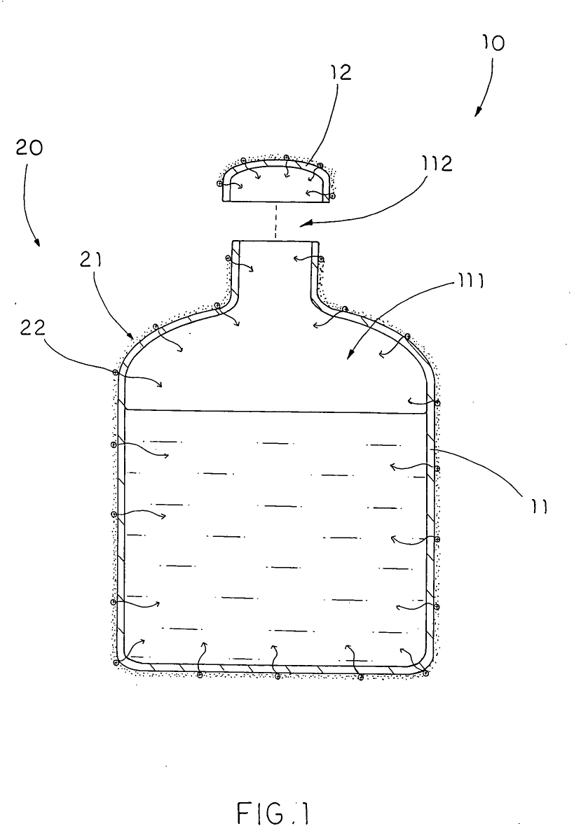

Referring to FIG. 1 of the drawings, a plastic water and beverage bottle for preserving a liquid according to a preferred embodiment of the present invention is illustrated, wherein the reusable plastic water and beverage bottle comprises a liquid container 10 and a protective arrangement 20.

The liquid container 10 comprises a plastic made container body 11 having a liquid chamber 111 for storing the liquid therein and an opening 112 communicating with the liquid chamber 111, and a plastic made container cap 12 detachably sealing at the opening 112 of the container body 111 to enclose the liquid chamber 111.

The protective arrangement 20, which is provided on the liquid container 10, comprises a nano titanium oxide 21 for blocking ultra-violet light entering into the liquid chamber 111 of the liquid container 10, and a far infrared ray emitter 22 mixed with the nano titanium oxide 21, wherein the far infrared ray emitter 22 is adapted for emitting far infrared rays penetrating into the liquid chamber 111 to depolarize negative ions of the liquid, in such a manner that the protective arrangement 20 forms as a germ barrier for keeping the liquid in the liquid container 10 in a germ-free manner.

The present invention further comprises a process of manufacturing a plastic water and beverage bottle which comprises the steps of:

(1) Provide the liquid container 10.

(2) Mix a predetermined amount of the far infrared ray emitter 22 with the nano titanium oxide 21 to form an anti-germ solution.

(3) Apply the anti-germ solution on the liquid container 10, wherein the anti-germ solution forms as a germ barrier for keeping the liquid in the liquid container 10 in a germ-free manner.

According to the preferred embodiment, the liquid container 10 is embodied as a conventional plastic container, wherein the container body 11 is allowed to be of any shapes and sizes, whether it is a sturdy water-dispenser type bottle or a handy plastic water and beverage bottle.

The container plastic made container cap 12 is sealing at the opening 112 of the container body 11, so as to prevent the liquid within the liquid chamber 111 of the container body 11 from leaking through the opening 112.

The far infrared ray emitter 22 emits far infrared rays with positive ions. As negative charge environment promotes bacterial growth, the emission of positive ions by the protective arrangement 20 of the liquid container 10 enables the exterior surface thereof to remain a positive charge environment, creating an unpleasant environment for bacteria and inhibiting bacteria growth. The container body 11 is therefore free of bacteria.

The function of the far infrared ray emitter 22 is not only limited to the exterior surface of the liquid container 10. The far infrared rays emitted by the emitter 15 are strong enough to penetrate through the container body 11 and the container cap 12 into the liquid chamber 111, providing ion pathways between the protective arrangement 20 and the liquid inside the container body 11 for the positive ions emitted. The positive ions emitted by the far infrared ray emitter 22 are therefore transported to the liquid into the liquid chamber 111 of the container body 11.

Acidic environment promotes bacterial growth because of the presence of the negative ions. As negative charge environment promotes bacterial growth, acidic beverages are more prone to promote bacterial growth. In order to inhibit that bacterial growth, the negative ions must be neutralized by the introduction of positive ions from the far infrared ray emitter 22.

By providing ion pathways between the protective arrangement 20 and the liquid chamber 111 of the container body 11, positive ions are carried towards the liquid chamber 111 of the container body 11, which neutralizes the negative ions and inhibits bacterial growth.

Furthermore, as the positive ions are carried to the liquid inside the container body 11, not only can the liquid inside the container body 11 can be kept free of germs, an inner wall of the container body 11 can be kept free of germs too, allowing the container body 11 to be reusable.

When the container body 11 and the container cap 12 are used for storing water, the infrared rays emitted by the far infrared ray emitters 22 are capable of softening the hardness of water. Despite the fact that hardness is not known to be related to any diseases or illnesses, it does contribute to strange tastes of water and beverages made by such hard water. By softening that water, the beverage can taste much better, and prevent any potential illnesses or diseases.

According to the preferred embodiment of the present invention, the far infrared ray emitter 22 is made of a kind of ceramic material that emits the far infrared rays.

Sunlight is known to alter beverage quality, such as altering the taste or the appearance, as a result, containers of most bottled water or beverages usually includes an advice saying that the beverages should not be placed directly sunlight. Despite the advice, it cannot be guaranteed that the beverages would not be in contact with sunlight. The beverages can easily be exposed to sunlight during transportation.

Nano titanium oxide 21 is a physical sunlight blocker, wherein particles of nano titanium oxide scatter, reflect or absorb solar radiation. The nano titanium oxide 21 of the protective arrangement 20 therefore forms a protective layer on the container body 11 and the container cap 12 respectively, capable of screening out ultra-violet rays from the sun.

In step (2), the far infrared ray emitter 22 is mixed with the nano titanium oxide 21 to form the anti-germ solution. The protective arrangement 20 is stable coatings that will not disintegrate or be washed off, therefore will not cause environmental pollution and facilitate the bottle to be reusable.

According to the preferred embodiment of the present invention, the anti-germ solution has 5% by weight of the far infrared ray emitter 22 and nano titanium oxide 21, and 95% by weight of water.

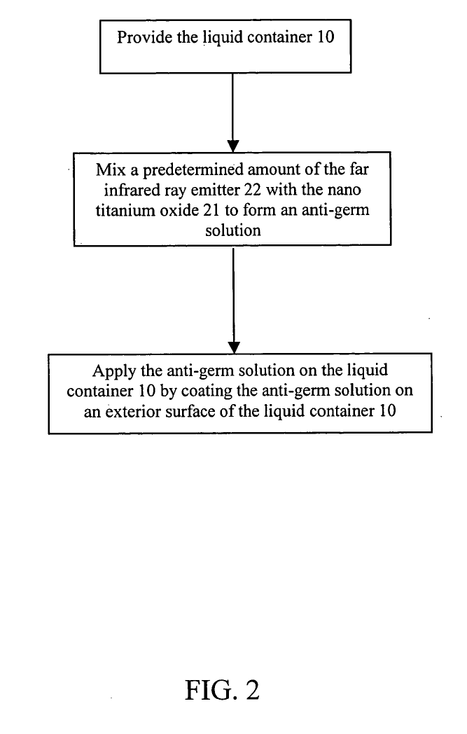

Referring to FIG. 2 of the drawings, a process of manufacturing the plastic water and beverage bottle according to the above preferred embodiment is disclosed. There is first a step of providing the liquid container 10 comprising the plastic made container body 11 and the plastic made container cap 12.

Then, there is a step of providing a predetermined amount of nano titanium oxide 21, a step of providing a predetermined amount of far infrared ray emitter 22 and a step of providing water. Then, the nano titanium oxide 21 and the far infrared ray emitter 22 are mixed together with water to form an anti-germ solution. There are then steps of applying the anti-germ solution on a body exterior surface of the liquid container 10.

In step (2), the far infrared ray emitter 22 is made by grinding the ceramic into a powder form while the nano titanium oxide 21 is made by grinding the titanium oxide into a fine particle having a nano size, such that the far infrared emitter 22 is mixed with the nano titanium oxide 21 to form the anti-germ solution by adding a predetermined amount of water into the mixture of the far infrared emitter 22 is mixed with the nano titanium oxide 21.

It is worth to mention that the liquid container 10 can be of any shapes or sizes. The manufacturing process as disclosed in the present invention is adapted for containers of any shapes or sizes so long as they are made of plastic. Existing liquid container 10 manufacturers can therefore benefit from the present invention without the need to altering their original design.

The anti-germ solution is applied to the container body 11 and the container cap 12 through a spraying device, wherein the anti-germ solution is evenly sprayed to cover the entire exterior surface of the liquid container 10.

According to this preferred process, the predetermined amount of nano titanium oxide 21 together with the predetermined amount of far infrared ray emitter 22 constitutes to 5% by weight of the anti-germ solution. The remaining 95% by weight of the anti-germ solution is water.

This manufacturing process enables bottles to be processed to possess the characteristics of being germs-free and ultra-violet rays blockage. The process is applicable to plastic made bottles of any shapes and sizes, enabling all plastic manufactured bottles to be equipped with such a protective arrangement.

As the nano titanium oxide and the far infrared ray emitter is capable of providing action from the exterior of the liquid container 10, the application of the anti-germ solution is on the exterior surface, instead of the interior surface of the liquid chamber 111. This can not only facilitate the process to be realized easily, it can also ensure the protective arrangement 20 to be evenly applied on the entire exterior surface.

It can also prevent the protective arrangement 20 from entering the content inside the liquid chamber 111. Even should the protective arrangement 20 may accidentally fall off from the exterior surface of the liquid container 10, it will not be able to enter the liquid chamber 11 to contaminate the liquid within the liquid chamber 111. Furthermore, the protective arrangement 20 being used on the exterior allows the bottle to be reused. As a result, this reusable plastic bottle protective arrangement does not have any potential health hazard and is therefore safe to use.

It is worth mentioning that after the step of providing the liquid container 10, there is a step of cleaning the liquid container 10, so as to provide a germs-free liquid container 10 before applying the anti-germ solution on the liquid container 10.

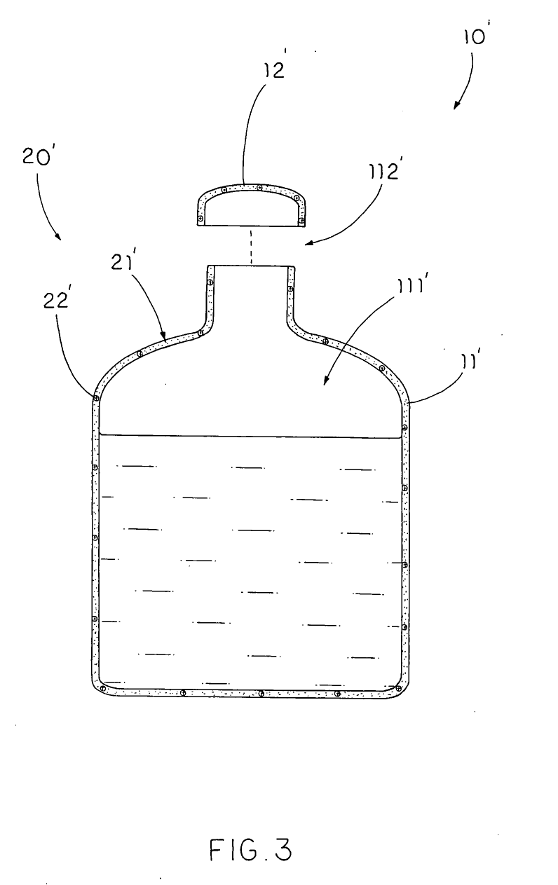

Referring to FIG. 3 of the drawings, a plastic water and beverage bottle of a second embodiment illustrates an alternative mode of the first embodiment of the present invention, wherein the plastic water and beverage bottle comprises a liquid container 10′ and a protective arrangement 20′ provided thereon.

The liquid container 10′ comprises a plastic made container body 11′ having a liquid chamber 111′ for storing the liquid therein and an opening 112′ communicating with the liquid chamber 111′, and a plastic made container cap 12′ detachably sealing at the opening 112′ of the container body 11′ to enclose the liquid chamber 111′.

The protective arrangement 20′ comprises a nano titanium oxide 21′ for blocking ultra-violet light entering into the liquid chamber 111′ of the liquid container 10′, and a far infrared ray emitter 22′ mixed with the nano titanium oxide 21′, wherein the far infrared ray emitter 22′ is adapted for emitting far infrared rays penetrating into the liquid chamber 111′ to depolarize negative ions of the liquid, in such a manner that the protective arrangement 20′ forms as a germ barrier for keeping the liquid in the liquid container 10′ in a germ-free manner.

According to the second embodiment, the liquid container 10′ is made of a predetermined amount of plastic material through a plastic molding process to form the container body 11′ and the container cap 12′.

The weight ratio between the predetermined amount of nano titanium oxide 21′ and the predetermined amount of plastic is 1:10,000. The weight ratio between the predetermined amount of far infrared ray emitter 22′ and the predetermined amount of plastic is also 1:10,000.

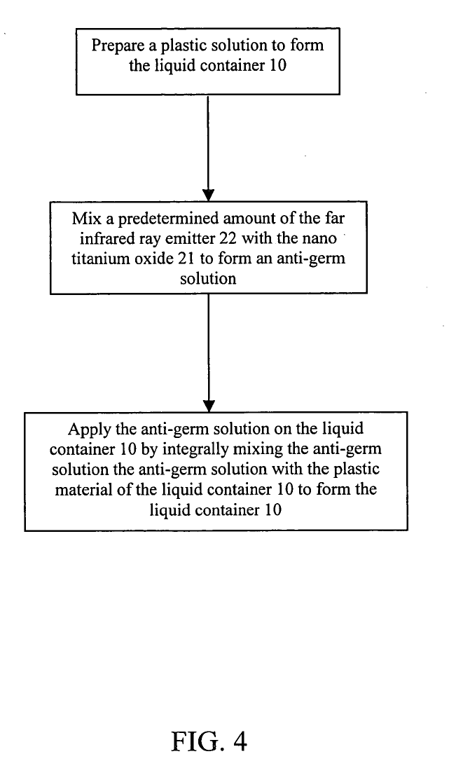

Referring to FIG. 4 of the drawings, a process of manufacturing a plastic water beverage bottle according to the second embodiment is disclosed. First, there is a step of providing a predetermined amount of plastic material.

There is then a step of providing an anti-germ solution, wherein the anti-germ solution is provided by mixing a predetermined amount of nano titanium oxide 21′ and a predetermined amount of far infrared ray emitter 22′.

Then a step of forming a compound material by integrally mixing the plastic material with the anti-germ solution follows, wherein the nano titanium oxide 21′ and the far infrared ray emitter 22′ are evenly distributed in the plastic material to form the compound material.

Finally there is a step of forming the liquid container 10′ using the compound material. The nano titanium oxide 21′ and the far infrared ray emitter 22′ are therefore evenly distributed inside the liquid container 10′.

In step (2), the far infrared ray emitter 22′ is made by grinding the ceramic into a powder form while the nano titanium oxide 21′ is made by grinding the titanium oxide into a fine particle having a nano size, such that the far infrared emitter 22′ is mixed with the nano titanium oxide 21′ to form the anti-germ solution mixing with the plastic to form the compound material as a raw material of the liquid container 10′.

According to the manufacturing process, the liquid container 10′ is made by the compound material through a process of injection molding, wherein the compound material is fed into an injection molding machine, which comprises an injection device and a mold, wherein the compound material is injected into the mold through the injection device.

In the step of providing the nano titanium oxide 21′, the weight ratio between the predetermined amount of nano titanium oxide 21′ and the predetermined amount of plastic is 1 to 10,000. In the step of providing the far infrared ray emitter 22′, the weight ratio between the predetermined amount of far infrared ray emitter 22′ and the predetermined amount of plastic is also 1 to 10,000.

As this alternative manufacturing process provides a liquid container 10′ that is made of a compound material provided by mixing the plastic, the nano titanium oxide 21′ and far infrared ray emitter 22′, it provides manufacturers the flexibility of designing their own shapes and sizes of bottle. As long as they can produce the mold, a bottle of any form can be produced simply by injecting the compound material into the mold and let the compound material to set and form a pre-desired shape of bottle.

The nano titanium oxide 21′ and the far infrared ray emitter 22′ are integral within the plastic means that they cannot enter the content inside the liquid chamber 111′ hence preventing them from contaminating the content while performing their functions of blocking ultra-violet light and inhibiting bacterial growth respectively.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. A plastic water and beverage bottle adapted for preserving a liquid, comprising:
a liquid container comprising a plastic made container body having a liquid chamber for storing said liquid therein and an opening communicating with said liquid chamber, and a plastic made container cap detachably sealing at said opening of said container body to enclose said liquid chamber; and
a protective arrangement provided on said liquid container, comprising:
a nano titanium oxide for blocking ultra-violet light entering into said liquid chamber of said liquid container; and
a far infrared ray emitter mixed with said nano titanium oxide, wherein said far infrared ray emitter is adapted for emitting far infrared rays penetrating into said liquid chamber to depolarize negative ions of said liquid, in such a manner that said protective arrangement forms as a germ barrier for keeping said liquid in said liquid container in a germ-free manner.

2. A plastic water and beverage bottle, as recited in claim 1, wherein said far infrared ray emitter of said protective arrangement is a ceramic powder.

3. A plastic water and beverage bottle, as recited in claim 1, wherein said far infrared ray emitter and said nano titanium oxide constitutes 5% by weight of said protective arrangement and water constitutes 95% by weight of said protective arrangement.

4. A plastic water and beverage bottle, as recited in claim 2, wherein said far infrared ray emitter and said nano titanium oxide constitutes 5% by weight of said protective arrangement and water constitutes 95% by weight of said protective arrangement.

5. A plastic water and beverage bottle, as recited in claim 1, wherein said protective arrangement is formed as an anti-germ solution coated on exterior surfaces of said container body and said container cap.

6. A plastic water and beverage bottle, as recited in claim 4, wherein said protective arrangement is formed as an anti-germ solution coated on exterior surfaces of said container body and said container cap.

7. A plastic water and beverage bottle, as recited in claim 1, wherein said protective arrangement is integrally mixed with a plastic material to integrally form said container body and said container cap of said liquid container.

8. A plastic water and beverage bottle, as recited in claim 2, wherein said protective arrangement is integrally mixed with a plastic material to integrally form said container body and said container cap of said liquid container.

9. A plastic water and beverage bottle, as recited in claim 7, wherein said far infrared ray emitter is in 1:10,000 weight ratio with a plastic material of said liquid container and said nano titanium oxide is in 1:10,000 weight ratio with said plastic material of said liquid container.

10. A plastic water and beverage bottle, as recited in claim 8, wherein said far infrared ray emitter is in 1:10,000 weight ratio with a plastic material of said bottle and said nano titanium oxide is in 1:10,000 weight ratio with said plastic material of said liquid container.

11. A process of manufacturing a plastic water and beverage bottle which comprises the steps of:
(a) providing a liquid container comprising a plastic made container body having a liquid chamber for storing said liquid therein and an opening communicating with said liquid chamber, and a plastic made container cap detachably sealing at said opening of said container body to enclose said liquid chamber;
(b) mixing a predetermined amount of far infrared ray emitter with a nano titanium oxide to form an anti-germ solution, wherein said nano titanium oxide is for blocking ultra-violet light entering into said liquid chamber of said liquid container, and said infrared ray emitter is adapted for emitting far infrared rays penetrating into said liquid chamber to depolarize negative ions of said liquid; and
(c) applying said anti-germ solution on said liquid container, wherein said anti-germ solution forms as a germ barrier for keeping said liquid in said liquid container in a germ-free manner.

12. The process, as recited in claim 11, wherein said far infrared ray emitter of said protective arrangement is a ceramic powder.

13. The process, as recited in claim 11, wherein in said step (c), said anti-germ solution is coated on exterior surfaces of said container body and said container cap.

14. The process, as recited in claim 12, wherein in said step (c), said anti-germ solution is coated on exterior surfaces of said container body and said container cap.

15. The process, as recited in claim 13, wherein said anti-germ solution is formed by constituting 5% by weight of said far infrared ray emitter and said nano titanium oxide and 95% by weight of water.

16. The process, as recited in claim 14, wherein said anti-germ solution is formed by constituting 5% by weight of said far infrared ray emitter and said nano titanium oxide and 95% by weight of water.

17. The process, as recited in claim 11, wherein said anti-germ solution is integrally mixed with a plastic material of said liquid container to integrally form said container body and said container cap of said liquid container.

18. The process, as recited in claim 12, wherein said anti-germ solution is integrally mixed with a plastic material of said liquid container to integrally form said container body and said container cap of said liquid container.

19. The process, as recited in claim 17, wherein said far infrared ray emitter is in 1:10,000 weight ratio with said plastic material of said liquid container and said nano titanium oxide is in 1:10,000 weight ratio with said plastic material of said liquid container.

20. The process, as recited in claim 18, wherein said far infrared ray emitter is in 1:10,000 weight ratio with said plastic material of said liquid container and said nano titanium oxide is in 1:10,000 weight ratio with said plastic material of said liquid container.
